(19) United States
(12) Patent Application Publication
(10) Pub. No.: US 2014/0218289 A1
(43) Pub. Date: Aug. 7, 2014

(54) ELECTRONIC DEVICE WITH CONTROL INTERFACE AND METHODS THEREFOR

(71) Applicant: MOTOROLA MOBILITY LLC, Libertyville, IL (US)

(72) Inventors: Hui Dai, Northbrook, IL (US); Phillip D. Rasky, Buffalo Grove, IL (US)

(73) Assignee: MOTOROLA MOBILITY LLC, Libertyville, IL (US)

(21) Appl. No.: 13/760,227

(22) Filed: Feb. 6, 2013

(51) Int. Cl. G06F 3/041

(52) U.S. Cl. CPC G06F 3/0416
USPC 345/157; 345/173

(57) ABSTRACT

An electronic device (100) includes a display (102), a communication circuit (103), and a control circuit (107). The control circuit (107) is configured to detect an interactive application (110) operating on a remote device (106). The control circuit can then present a control interface (300) on the display to receive user input (400) for interactive regions (301) of the interactive application. The communication circuit can communicate the user input to the remote device to control the interactive application. The user input can optionally be mapped to the interactive regions of the interactive application. Control interface data can be mapped to the interactive application as well.

### TECHNICAL FIELD

This disclosure relates generally to electronic devices, and more particularly to user interfaces for electronic devices.

### BACKGROUND ART

“Intelligent” portable electronic devices, such as smart phones, tablet computers, and the like, are becoming increasingly powerful computational tools. Moreover, these devices are becoming more prevalent in today's society. For example, not too long ago mobile telephones were simplistic devices with twelve-key keypads that only made telephone calls. Today, “smart” phones, tablet computers, personal digital assistants, and other portable electronic devices not only make telephone calls, but also manage address books, maintain calendars, play music and videos, display pictures, and surf the web.

As the capabilities of these electronic devices have progressed, so too have their user interfaces. Prior keypads having a limited number of keys have given way to sophisticated user input devices such as touch sensitive screens or touch sensitive pads. Touch sensitive systems, including touch sensitive displays, touch sensitive pads, and the like, include sensors for detecting the presence of an object such as a finger or stylus. By placing the object on the touch sensitive system, the user can manipulate and control the electronic device without the need for a physical keypad.

One drawback associated with these touch sensitive systems concerns the user experience. Many applications today are being designed to primarily function with an electronic device having a touch sensitive surface. When one wants to operate such an application with a non-touch sensitive device, adapting the user interface for the non-touch sensitive device can be problematic. An improved electronic device would offer an enhanced user experience by making control of applications more intuitive.

### BRIEF DESCRIPTION OF THE DRAWINGS

FIG. 1 illustrates one explanatory embodiment of an electronic device configured in accordance with one or more embodiments of the disclosure.

FIG. 2 illustrates one explanatory method configured in accordance with one or more embodiments of the disclosure.

FIGS. 3-6 illustrate an explanatory electronic device configured in accordance with one or more embodiments of the disclosure, operating in an explanatory embodiment to execute one or more steps of one or more methods configured in accordance with one or more embodiments of the disclosure.

FIG. 7 illustrates another explanatory embodiment of an electronic device configured in accordance with one or more embodiments of the disclosure.

FIGS. 8-16 illustrates another explanatory electronic device configured in accordance with one or more embodiments of the disclosure, operating in an explanatory embodiment to execute one or more steps of one or more methods configured in accordance with one or more embodiments of the disclosure.

FIG. 17 illustrates explanatory control interfaces configured for operation in one or more electronic devices configured in accordance with one or more embodiments of the disclosure.

FIG. 18 illustrates one explanatory embodiment of a remote device controlling a target device configured in accordance with one or more embodiments of the disclosure.

FIGS. 19-20 illustrate an explanatory remote device operating in an explanatory embodiment to execute one or more steps of one or more methods to control a target electronic device configured in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF EMBODIMENTS OF THE DISCLOSURE

Before describing in detail embodiments that are in accordance with the explanatory disclosure, it should be observed that the embodiments reside primarily in combinations of method steps and apparatus components related to detect interactive applications operating on a remote device, present a control interface on the display to receive user input for interactive regions of the interactive application, and communicate the user input to the remote device to control the interactive application. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the several embodiments so as not to obscure the disclosure with details that will be readily apparent to those of ordinary skill in the art having the benefit of the description herein.

It will be appreciated that embodiments described herein may be comprised of one or more conventional processors and unique stored program instructions that control the one or more processors to implement, in conjunction with certain non-processor circuits, some, most, or all of the functions of methods for detecting interactive applications operating on remote devices, presenting control interfaces to control the interactive applications on a local device, and communicating control input received at the local device to the remote device as described herein. The one or more conventional processors may additionally implement and execute an operating system, with the methods described below being configured as an application operating in the environment of the operating system. For example, one or more of the embodiments described below are well suited for configuration as an application adapted to operate in the Android™ operating system manufactured by Google, Inc.

The non-processor circuits may include, but are not limited to, a radio receiver, a radio transmitter, signal drivers, clock circuits, power source circuits, and user input devices. As such, these functions may be interpreted as steps of a method to perform control of an interactive application operating on a remote device by presenting a control interface on a local device, receiving user input, and communicating the user input to the remote device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

One or more embodiments are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in a figure other than figure A.

Embodiments described herein provide an electronic device, referred to colloquially as a “target device,” configured to execute a method of controlling an interactive application operating on a remote device. In one embodiment, the electronic device includes a display, a communication circuit, and a control circuit. The control circuit executes instructions configured in the form of executable code to detect, with the communication circuit, the interactive application operating on the remote device. The control circuit then presents a control interface on the display of the electronic device. The control interface is configured to receive user input for interactive regions of the interactive application. In one embodiment, the user input comprises gestures detected on a touch sensitive surface of the display. When user input is received, the control circuit causes the communication circuit to communicate the user input to the remote device to control the interactive application. In one embodiment, the user input communicated to the remote device is mapped to one or more interactive regions of the interactive application.

In another embodiment, the control circuit activates an application configured for interactive operation on a single display. Despite the fact that the application is designed to work only on a single display that is local to the electronic device, in one embodiment the control circuit causes the communication circuit to communicate presentation data of the application for presentation on a remote display device. This can be done in one embodiment by mapping the application to a display region of the electronic device that exceeds the presentation area of the display, and then communicating data presented in areas of the display region outside the presentation area to the remote device.

Once the application, or portions thereof, is being communicated to the remote device, in one embodiment the control circuit presents a control interface for the application on the display. When user input is received at the control interface, the control circuit causes the communication circuit to communicate user input received at the control interface to control the presentation data of the application on the remote display device.

In one embodiment, the communication circuit is operable with a local Wi-Fi network and allows a user to display content from the “single display” application on external large screen devices, one example of which may be a wide screen, high definition television. Since the screen of the television may not be touch sensitive, and as it is inconvenient to attempt to control interactive applications operating on a television with a remote control due to the cumbersome user interface and lack of correspondence between remote control keys and the interactive regions of the interactive application, embodiments described herein allow the user to employ the control interface presented, automatically in one or more embodiments, on the display of a mobile device. Rather than “mirroring” the entire wide screen television screen on the mobile device, which causes the text to become illegible due to the small size of the display on the mobile device and further requires extensive computing power in the mobile device, one or more embodiments provide a control interface that provides an “easy to use” user interface that does not require the single display application to be reconfigured in anyway. Furthermore, there is no requirement for the remote screen to be mirrored.

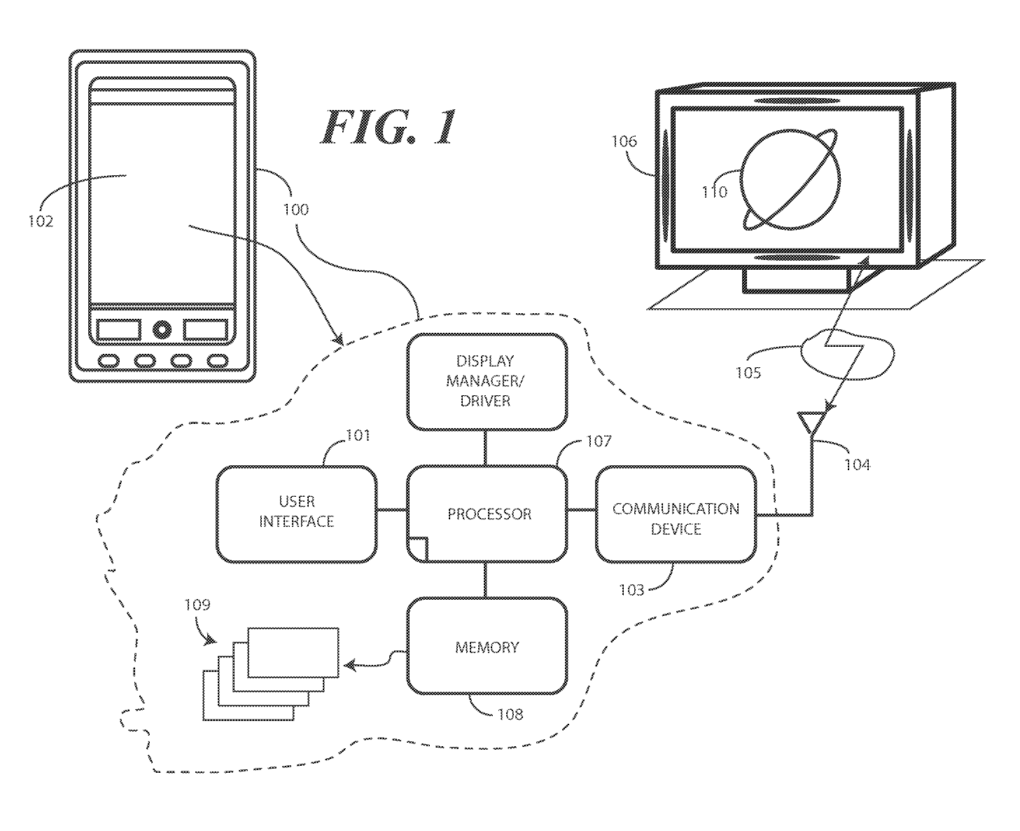

Turning now to FIG. 1, illustrated therein is an explanatory electronic device 100 configured in accordance with one or more embodiments of the disclosure. The illustrative electronic device 100 of FIG. 1 is shown as a smart phone for illustration. However, it will be obvious to those of ordinary skill in the art having the benefit of this disclosure that other portable electronic devices may be substituted for the explanatory smart phone of FIG. 1. For example, the electronic device 100 may be configured as a palm-top computer, a tablet computer, a gaming device, wearable computer, a media player, laptop computer, portable computer, or other device. The electronic device 100 can be referred to as the “target device” for the purposes of this disclosure.

The explanatory electronic device 100 is shown illustratively in FIG. 1 in an operating environment, along with a schematic block diagram, incorporating explanatory embodiments of the present disclosure. As shown, the illustrative electronic device 100 may include standard components such a user interface 101. The user interface 101 can include the display 102, which in one embodiment is a touch sensitive display. Display 102 can be referred to as the “target” display.

The illustrative electronic device 100 of FIG. 1 also includes a communication circuit 103. The communication circuit 103 can be configured for communication with one or more networks, such as a wide area network. The communication circuit 103 can also be configured to communicate with a local area network or short-range network as well. The communication circuit 103 can include wireless communication circuitry, one of a receiver, a transmitter, or transceiver, and one or more antennas 104.

In one or more embodiments, the communication circuit 103 can be configured for data communication with at least one wide area network. For illustration, where the electronic device 100 is a smart phone with cellular communication capabilities, the wide area network can be a cellular network being operated by a service provider. Examples of cellular networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, and other networks. It should be understood that the communication circuit 103 could be configured to communicate with multiple wide area networks as well.

The communication circuit 103 can also be configured to communicate with a local area network 105, such as a Wi-Fi network being supported by a router, base station, or access point. In the illustrative embodiment of FIG. 1, the communication circuit 103 is communicating across the local area network 105 with a remote device 106, shown illustratively here as a remote monitor or television. In context, the communication circuit 103 of electronic device 100, i.e., the target device, is communicating across the local area network 105 with the remote device 106, as the “target” device is the device having the smaller display as that term is used in this disclosure. It should be noted that the communication circuit 103 can also be configured to communicate across other types of local area networks, including Bluetooth™ or other local area communication protocols.

The remote device 106 is shown in FIG. 1 operating an interactive application 110. The term “interactive application” is used herein to describe an application that can receive user input to manipulate the content being presented on the remote device 106. Illustrating by example, a web browser would constitute an interactive application in that a user can select the uniform resource locator (URL) from which the web browser should pull information. Additionally, the user can provide input, such as scrolling or clicking on links, to change the information being presented on the display. Scrolling the web page up or down changes the information being presented. Similarly, clicking on a link may change the URL from which the browser draws information.

Another example of an interactive application would be a gaming application where a user can control the actions of the game by delivering user input to the remote device 106. Still another example of an interactive application would be a virtual sketching or painting application where a user could create virtual drawings or paintings on the display of the remote device 106. Interactive applications are frequently identified by the use of a cursor or other actuation object that the user can move along the display to actuate or control various interactive regions of the interactive application.

In this illustrative embodiment, the electronic device 100 includes a control circuit 107, which in FIG. 1 is illustrated as one or more processors. The control circuit 107 is responsible for performing the various functions of the device. The control circuit 107 can be a microprocessor, a group of processing components, one or more Application Specific Integrated Circuits (ASICs), programmable logic, or other type of processing device. The control circuit 107 can be operable with the user interface 101 and the communication circuit 103, as well as various peripheral ports (not shown) that can be coupled to peripheral hardware devices via interface connections.

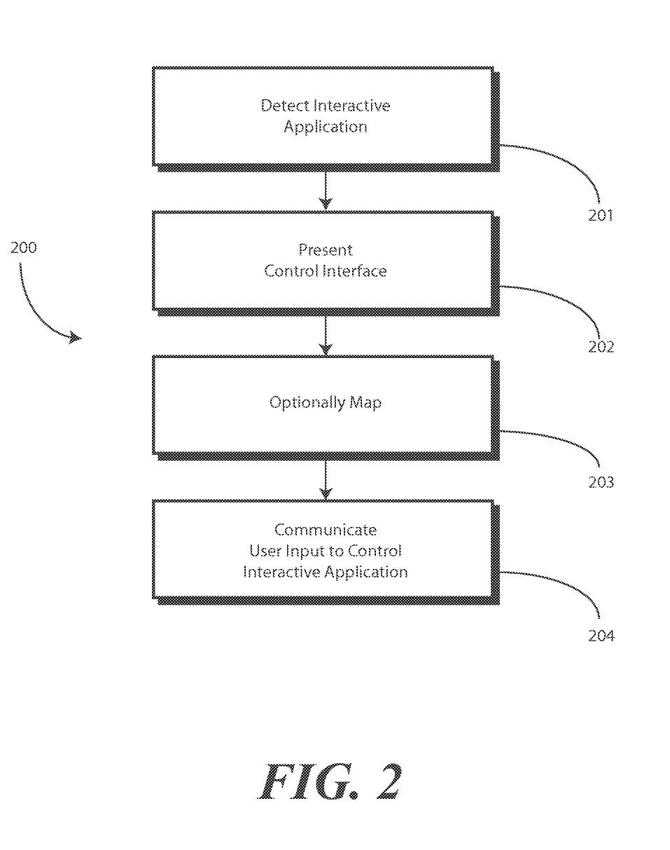

The control circuit 107 can be configured to process and execute executable software code to perform the various functions of the electronic device 100. A storage device, such as memory 108, stores the executable software code used by the control circuit 107 for device operation. The executable software code used by the control circuit 107 can be configured as one or more modules 109 that are operable with the control circuit 107. Such modules 109 can comprise instructions, such as control algorithms, that are stored in a computer-readable medium such as the memory 108 described above. Such computer instructions can instruct processors or the control circuit 107 to perform methods described below in FIGS. 2-6 and 8-16. In other embodiments, additional modules could be provided as needed.

Turning now to FIG. 2, illustrated therein is one explanatory method 200 of operating the electronic device (100) of FIG. 1 in accordance with one or more embodiments of the disclosure. The method 200 of FIG. 2 is suitable for coding as one of the modules (109) described above for execution with the control circuit (107).

At step 201, an interactive application (110) is detected operating on a remote device (106). In one embodiment, the remote device (106) is in communication with a communication circuit (103) of the electronic device (100).

At step 202, a control interface is presented on a user interface (101) of the electronic device (100). In one embodiment, the control interface is configured to allow a user to control the interactive application (110) operating on the remote device (106) from the display (102) or other user interface (101) of the electronic device (100). User input can be received at the display (102) or user interface (101) of the electronic device (100) at the control interface.

In one or more embodiments, this step 202 can optionally include mapping a portion of the information of the interactive application (110) that is visible on the remote device (106) in the control interface. For example, where the interactive application (110) is a web browser having a scroll bar with which a user may move the displayed website up and down, the scroll bar would constitute an interactive region of the interactive application (110). Accordingly, in one embodiment, step 202 can include mapping the scroll bar or a portion thereof in the control interface.

In one embodiment, at optional step 203, a portion of the control interface can be mapped to the display of the remote device (106) as well. For example, when the control interface corresponds to only a portion of the displayed content, such as an interactive region (which may be one of many interactive regions) of the interactive application (110), a user may want a visual indicator of what portion of the content is presently controllable with the control interface. Accordingly, in one embodiment a portion of the control interface or an indicator thereof can be mapped to the content on the remote device (106) so that the user can identify and/or adjust the portion or interactive region of the content being controlled.

At step 204, the user input received at the control interface can be communicated to the remote device (106) to control the interactive application (110). In one or more embodiments, this step 204 comprises mapping the user input to interactive regions of the interactive application.

The method 200 of FIG. 2 provides a tool, operable on an electronic device (100), which can be configured to map a portion of content of an interactive application (110) on a big screen, e.g., remote device (106), to be presented on a smaller screen, e.g., the display (102) of the electronic device (100). The control circuit (107) of the electronic device (100) can then present a control interface on the display (102). Manipulation of the control interface can generate, for example, cursor movement or other content manipulation on the big screen. In one or more embodiments, a visual indicator of the control interface can be presented on the big screen as well. This visual indicator can be configured to “float” along the content of the interactive application (110) so that the user may select which interactive region they wish to control. A simplified remote control, and one that provides an enhanced user experience, results.

Many prior art devices attempt to facilitate control of a remote device by mirroring the display of the remote device on a local device. As noted above, this method creates distinct problems. First and foremost, attempting to mirror a remote display on a local device requires significant computing and memory resources. Second, mirroring causes power consumption in the local device to increase, thereby decreasing the operable run time. Third, there can be significant latency between display updates on the local and remote devices. As one example, the remote display may have one hundred or more milliseconds of communication and/or processing delay than does the local display. This may cause less than desirable user experiences, especially when the interactive application is a gaming application. Finally, the remote display may have a different resolution from the local display, which results in the mirrored content not presenting the finer details on the local display due to its small size.

Embodiments of the present disclosure, such as the method 200 shown in FIG. 2, provide a solution that overcomes each of these problems. In one embodiment, the method maps only a portion of the content of the interactive application (110) operating on the remote device (106) on the display (102) of the electronic device (100), thereby saving processing power and conserving energy. Additionally, as only a portion of the content is mapped, the finer details can still be displayed. Moreover, latency is cut as only a portion of the information need be communicated between the remote device (106) and the electronic device (100). In one embodiment, the mapped portion of the content from the interactive application (110) comprises only selectable or “touch controllable” regions of the interactive application (110), which appears on the display (102) of the electronic device (100).

In one or more embodiments, the control interface presented at step 202 can be associated with expected types of user input or interactions. For example, if the mapped portion of the content of the interactive application (110) is a scroll bar, expected interactions may be dragging motions. Accordingly, the control interface may be uniquely designed to allow the user to perform dragging operations. Similarly, if the mapped portion of the content of the interactive application (110) corresponds to, for example, a hyperlink, the expected interaction may be a touch input. The control interface presented at step 202 can be uniquely configured to permit simple touch inputs. Further, in one or more embodiments, the control interface presented at step 202 can change as the mapped portion of the content of the interactive application (110) changes. While touch and drag interactions are two examples of expected interactions, it should be obvious to those of ordinary skill in the art having the benefit of this disclosure that other interactions could be expected as well, including extended touch, gestures, patterns, and so forth.

In another embodiment, the method 200 of FIG. 2 can be used to provide a control interface that is operable with a library of interactive elements that are stored in a memory (108) of the electronic device (100). The interactive elements can be associated with predetermined mapping and user input actions to control the interactive application (110) operating on the remote device (106). A module (109) of the electronic device (100) can accept action requests from the remote device (106) and generate appropriate simulated user input activities, including touch gestures, drag gestures, and so forth, on the display (102) of the electronic device (100). The communication circuit (103) of the electronic device (100) can then communicate user input received at the electronic device (100) to a runtime component of the interactive application (110) operating on the remote device (106) to control the interactive application (110). A “runtime system,” which may also be referred to as a “runtime environment” or just a “runtime,” is a system that implements the core behavior of a computer language. A “runtime system component” is an application operating on the runtime system. Regardless of type, every computer system implements some form of runtime system, with runtime components operating in that system. Runtime systems implement the basic low-level behavior, while runtime system components provide higher level functionality. Note that in one or more embodiments, the control interface presented at step 202 can be user selectable, so that the user may select a desired control interface that corresponds with a particular interactive application (110). Due to the mapping aspect occurring in one or more embodiments, the full content of the interactive application (110) in one embodiment is displayed only on the remote device (106), while specific control interface elements are displayed on the display (102) of the electronic device (100).

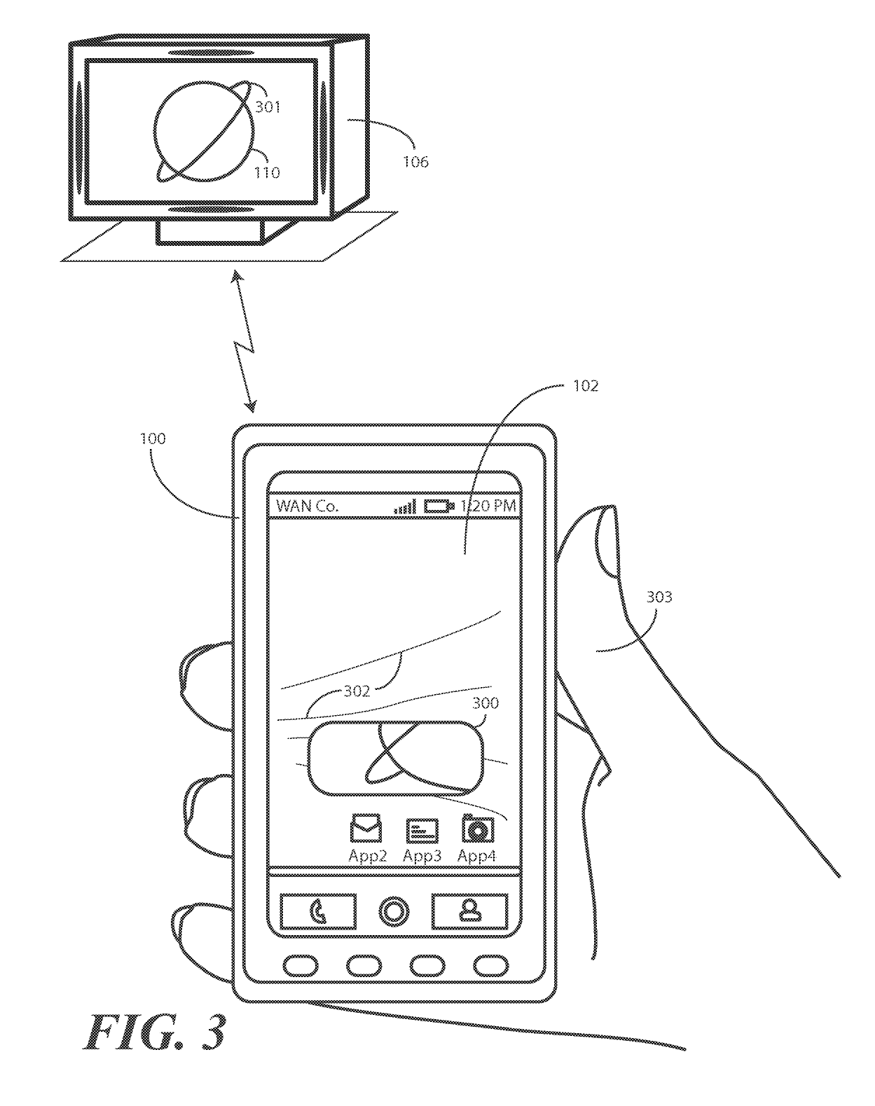

While one example of an electronic device (100) and one illustrative method (200) have been described, operation of the various aspects of embodiments of the disclosure may become more clear with the illustration of the electronic device (100) performing various method steps in an example or two. One such example is illustrated in FIGS. 3-6.

Turning now to FIG. 3, illustrated therein is an electronic device 100 in communication with a remote device 106. The electronic device 100 includes a display 102, which in this embodiment is a touch sensitive display and constitutes the primary user interface of the electronic device 100. A control circuit of the electronic device (100) detects, via a communication circuit of the electronic device (100), that an interactive application 110 is operating on the remote device 106.

Upon detecting that the interactive application 110 is operating on the remote device 106, the control circuit of the electronic device in one embodiment presents a control interface 300 on the display 102 of the electronic device 100. In one embodiment, this presentation occurs automatically. In one embodiment, the control interface 300 comprises a selection one of a plurality of predefined control interfaces stored in a memory of the electronic device 100, where each of the plurality of predefined control interfaces is associated with a predetermined touch control interaction as previously described. The control interface 300 in one embodiment is specific to the interactive application 110, i.e., it includes a shape, control, or actuation target that is specifically configured to control the interactive application 110. In other embodiments, the control interface 300 is general in that it can be used to control different interactive applications. The explanatory control interface 300 of FIG. 3 is configured to receive user input for interactive regions 301 of the content presented by the interactive application 110.

The control interface 300 can take a variety of forms. In one embodiment, the control interface 300 is in the form of a graphical “widget” that is presented on only a portion of the display 102 of the electronic device 100 and that “floats” above other information 302 being presented on the display 102. In one embodiment, the portion of the display 102 upon which the control interface 300 is presented is user configurable. While the control interface 300 can be configured based upon the input control needs of the interactive application 110, in one embodiment the control interface 300 can be one of a plurality of control interfaces. For example, one control interface may be a scrolling control interface, while another may be a press control interface. One control interface may be a pinch control interface, while another control interface is a stretch control interface, and so forth. The various control interfaces may be visually different so that an associated expected user interaction is evident to a user 303 by the shape, contour, color, or other visually distinguishing identifier of the control interface.

Illustrating by example, a scrolling control interface may be configured as a lengthy rectangle, while a press control interface may be configured as a small circle. Similarly, a pinch control interface may be a geometric shape having one or more concave sides, while a stretch control interface may be a geometric shape having one or more convex sides. In one embodiment, the plurality of control interfaces can be stored in a library of interactive elements resident in a memory of the electronic device (100). The control circuit may select the proper control element based upon the mapping occurring between the content of the interactive application (110) and the electronic device 100, or upon other criteria. In other embodiments, a user may select the proper control interface. As noted above, as the mapped region of the content of the interactive application changes, the control interface can dynamically change in real time as well.

In one or more embodiments, the control circuit of the electronic device 100 detects the interactive application 110 operating on the remote device 106 and presents a preconfigured control interface designed to control interactive regions of the content presented by the interactive application 110. Examples of preconfigured control interfaces include a scrolling control interface for a web browsing interactive application, a media controlling control interface comprising multiple buttons or virtual user actuation targets for a media player interactive application, or a keyed control interface for a gaming interactive application.

In one or more embodiments, the graphical appearance and/or layout of the control interface 300 does not “match” or otherwise mirror the user interface of the interactive application 110 visible on the remote device 106. In such embodiments, the control circuit of the electronic device 100 translates user input applied to the control interface 300 into preconfigured input events for communication to the remote device 106 to control the interactive application 110. Said differently, the logic employed by the control circuit of the electronic device 100 in presenting the control interface 300 need not understand the logic used by the interactive application 110 to control its content. Instead, the control interface 300 functions as a receiver of user input. This user input is then communicated to the remote device 106 after a predefined transformation, which in one embodiment is performed by the control circuit of the electronic device 100. Advantageously, when using such an embodiment, there is absolutely no change required for the interactive application 110, i.e., no reconfiguration or reprogramming, because the interactive application 110 needs only to react to communicated user input in the same way it would if the interactive application 110 were operating on the electronic device 100 itself.

While one control interface 300 is shown on the display 102 of the electronic device 100 in the illustrative embodiment shown in FIG. 3, it should be understood that a plurality of control interfaces could be presented as well. For example, if the interactive application 110 includes multiple interaction regions, in one embodiment multiple control interfaces could be presented on the display 102 of the electronic device to control the various interaction regions of the interactive application 110. As the presentation of too many control interfaces may begin to cover a significant portion of the display 102, in one embodiment each control interface is configured such that the user 303 can define the various control interfaces in tiered levels. A first tier can comprise a full size control interface with all options, while a second tier can comprise a smaller control interface configured for quick access with minimum controls. In one or more embodiments, the user 303 has the option to “shrink” or minimize the control interfaces when they do not desire to control the interactive application 110 and need to see the other information 302 on the display 102 of the electronic device 100.

As previously mentioned, in one or more embodiments the control interface 300 can perform a translation prior to communicating user input to the remote device 106 for controlling the interactive application 110. The following list provides examples of such translations: A touch control interface can be configured to deliver selection or touch input to a mapped portion of content presented by the interactive application 110. Accordingly, the touch control user interface can receive touch input and translate it to a predetermined location along the content.

A scrolling control interface configured as a scroll bar can receive dragging or scrolling user input and can translate that user input into a predefined curve that corresponds to an interaction region of the content presented by the interactive application 110. A rotating control interface, which can appear as a “ball” on the display 102 of the electronic device 100 in one embodiment, can translate an amount of rotation of the ball to an amount of rotation for the content presented by the interactive application 110. A stretch control interface, which can allow two fingers to stretch the ball, can translate an expansion input to interactive portions of the content presented by the interactive application 110.

In one or more embodiments, the control interface 300 is customized for the interactive application 110. For example, in one embodiment the control circuit of the electronic device 100 uses a plurality of control templates stored in memory that are common with popular applications to configure the control interface 300. In one or more embodiments, the control circuit of the electronic device 100 can be configured to change the control interface 300 when the interactive application 110 operating on the remote device 106 changes.

In one or more embodiments, the control circuit of the electronic device 100 allows the user 303 to control the design of the control interface 300 as well. In one embodiment, the user 303 can launch the interactive application 110 on the remote device 106 and then, using a camera of the electronic device 100 or other means, can capture a screen shot of a portion of the display of the remote device 106. A configuration module operating on the electronic device 100 then searches the library of control templates to determine whether a particular control interface has been designed for the interactive application 110. If not, the configuration module allows a new entry to be created in the control module library that will be associated with the interactive application 110. In one embodiment, the screen shot can be presented on the display 102 of the electronic device 100 so that the user 303 can confirm that the desired control interface will be used. The user 303 can then select the size and orientation of the control interface, and can move the control interface along the display 102 of the electronic device 100. In one embodiment, the user 303 may employ the initially captured screen shot as a starting point for the control interface. In one or more embodiments, the user 303 can also define a relative speed and scale factor for location transformation. Every control interface can optionally have a name displayed proximally thereto, so the user 303 can easily remember what the control interface does. When the user 303 closes the control interface, it can be saved into the library. When the interactive application 110 is launched subsequently, the control interface may automatically appear on the display 102 of the electronic device 100.

In one or more embodiments, the control interface 300 can be a singularly configured control interface that provides different control input to different interactive applications. Since the control circuit of the electronic device 100 may not be aware of the logic state of the interactive application 110 operating on the remote device 106, in one embodiment, the control circuit of the electronic device 100 receives runtime feedback from the interactive application 110 running on the remote device 106. For example, an event call back application protocol interface can be designed for the interactive application 110 to provide current runtime status information back to the control circuit of the electronic device 100 via the communication circuit in one embodiment.

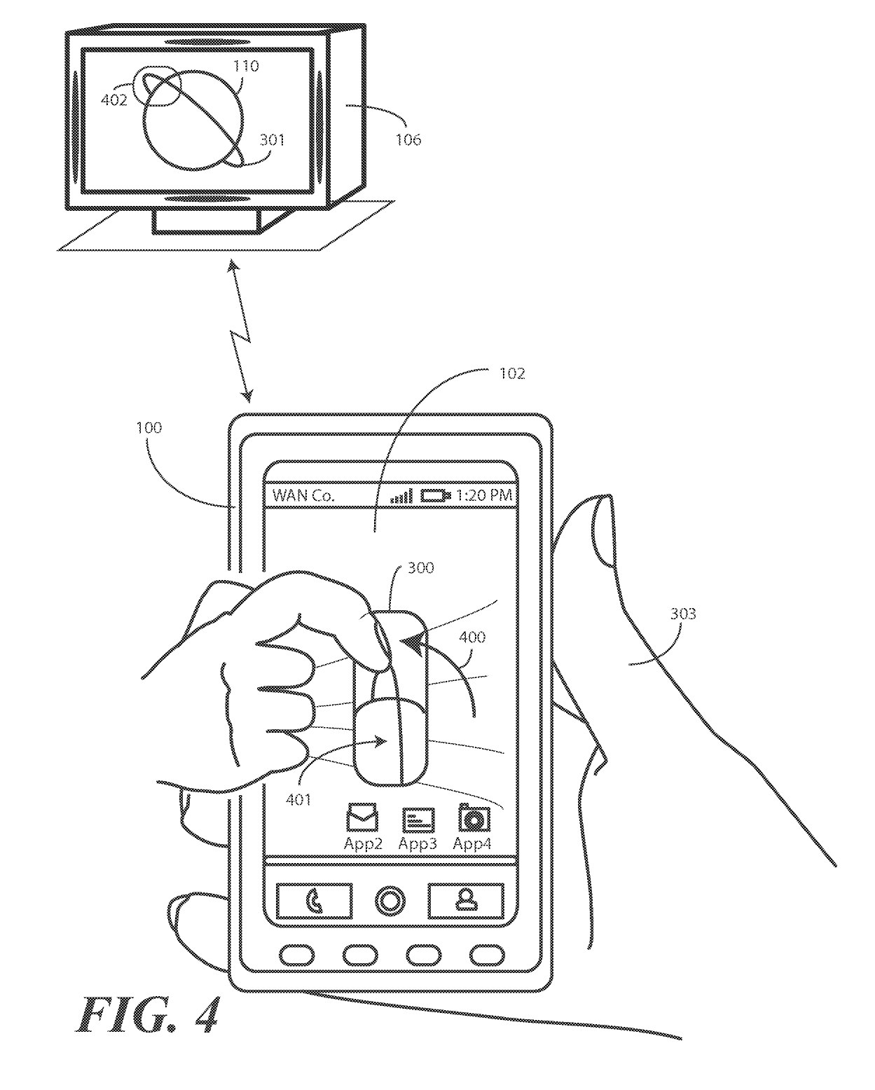

Turning now to FIG. 4, the user 303 is applying user input 400 to the control interface 300. In this illustrative embodiment, the user input 400 comprises a rotational input. The control circuit of the electronic device 100 then communicates this user input 400 to the remote device 106 to control the interactive application 110. As shown and compared to FIG. 3, the content presented by the interactive application 110 has rotated by an amount proportional to the user input 400.

In this illustrative embodiment, the user input 400 has been mapped to the interactive region 301 of the content presented by the interactive application 110. Accordingly, the content presented by the interactive application 110 has moved just as if the user 303 had touched the interactive region 301 on the remote device 106 and made the rotational input. However, since in this embodiment the display of the remote device 106 is not touch sensitive, the user 303 may make a simple touch gesture on the electronic device 100 to control the content. Advantageously, there is no need to operate user interface devices with inputs that do not correspond to the actions normally used to control the content of the interactive application 110.

As noted above, in one or more embodiments, the control interface 300 can comprise a mapping of a portion of information 401 of the interactive application 110 visible on the remote device 106 on the display 102 of the electronic device 100. This occurs in FIG. 3, as a portion of the ball and circle shown on the display of the remote device 106 has been mapped and rendered inside the control interface 300. The portion of the ring shown in the control interface 300 results in the portion of information comprising a portion of the interactive region 301 of the interactive application 110.

In some embodiments, a portion of the control interface 300 can be mapped to the interactive application 110 as well. In the illustrative embodiment of FIG. 4, the control circuit of the electronic device 100 has caused the communication circuit to communicate a mapping 402 of control interface data to the remote device 106 to be superimposed on a portion of information of the interactive application 110 visible on the remote device 106. This mapping 402 allows the user 303 to easily identify what portion of the information of the interactive application 110 is being controlled. While the mapping 402 is illustratively shown as a box in FIG. 4, in other embodiments it can be a cursor, cross hairs, or other visual indicator.

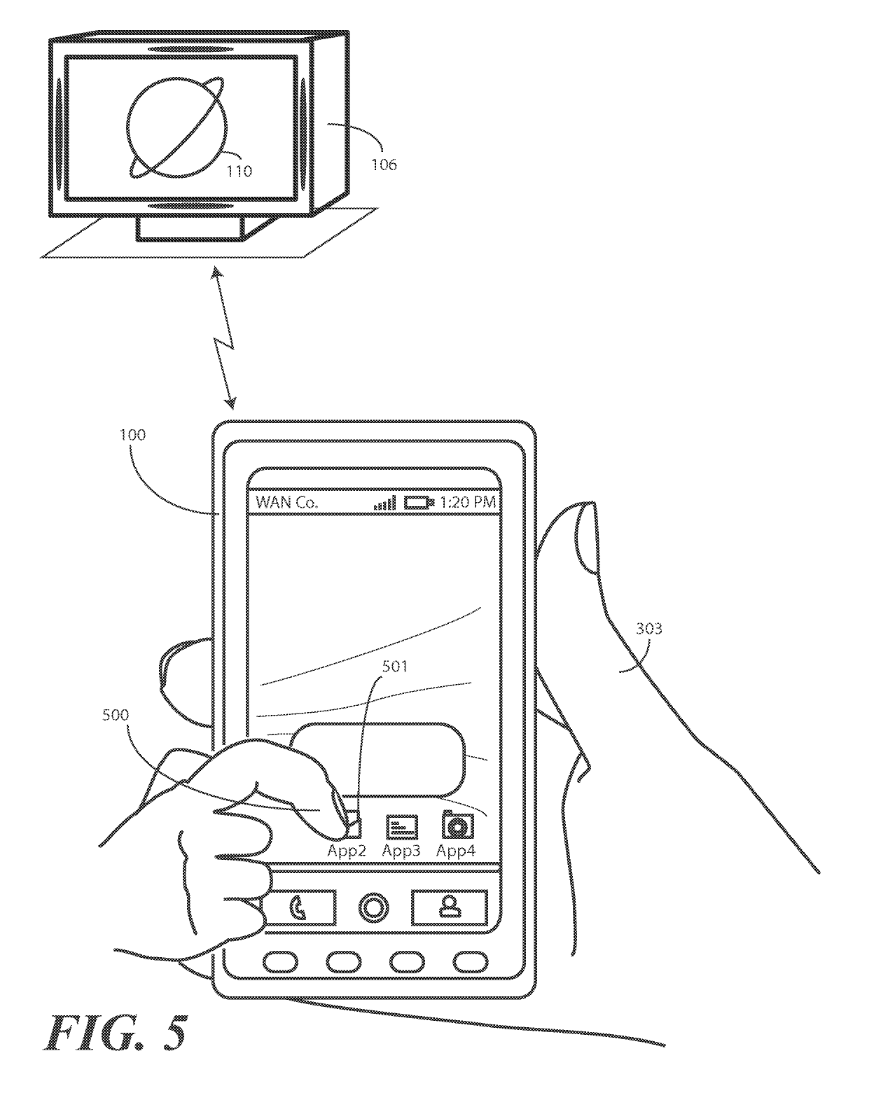

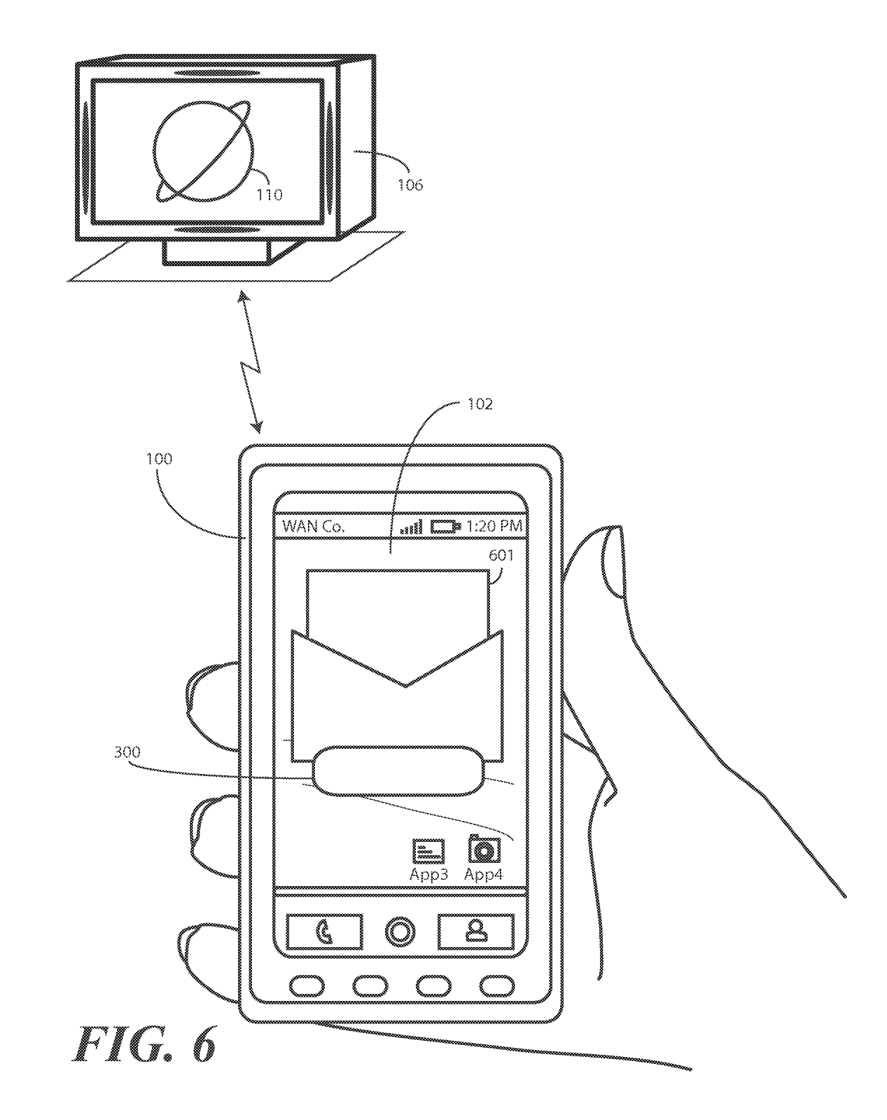

One of the advantages of presenting the control interface 300 on only a portion of the display 102 of the electronic device 100 is that other portions of the display 102 are available for other uses. Turning now to FIG. 5, the user 303 is applying another user input 500, which causes the control circuit of the electronic device 100 to selectively launch an application 501, which is different from the interactive application 110 operating on the remote device 106. As shown in FIG. 6, information 601 of this second application 501 is therefore presented on the display 102 of the electronic device 100. As shown, the control interface 300 has become reduced in size to allow the information 601 from the second application 501 to be shown on the display 102 of the electronic device 100. In some embodiments, the control interface 300 may be moved aside of the information 601 of the second application 501. However, in FIG. 6, the control circuit of the electronic device causes the control interface 300 to float above the information 601 of the second application 501. Whether the control interface 300 floats over other information or is moved to the side can be a user configurable option. Additionally, in one or more embodiments the user 303 may selectively resize the control interface 300 as desired.

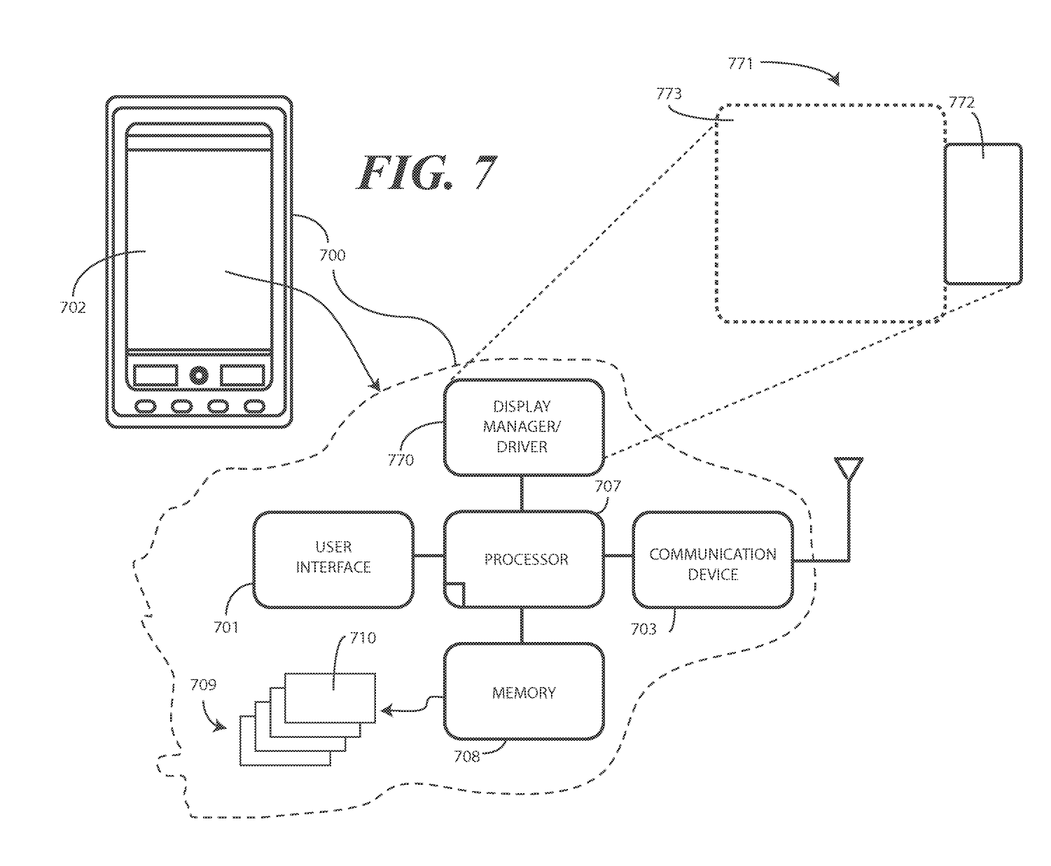

While detecting an interactive application 110 operating on a remote device 106, and providing a control interface 300 on an electronic device 100 to receive user input for controlling the interactive application 110 is one method of operating the electronic device 100 in accordance with embodiments of the disclosure, the various embodiments can be used to communicate application data from the electronic device 100 to a remote device 106 and correspondingly control the application data using a control interface 300 as well. Turning now to FIGS. 7-16, such an embodiment will be described.

Beginning with FIG. 7, illustrated therein is another electronic device 700 configured in accordance with one or more embodiments of the disclosure. The electronic device 700 of FIG. 7 includes many components that are common with the electronic device (100) of FIG. 1, including the user interface 701, control circuit 707, communication circuit 703, and memory 708.

In the illustrative embodiment of FIG. 7, the electronic device 700 includes a display manager 770 that is operable to control presentation data. The display manager 770 can present data in a presentation region 771 that includes a presentation region 772 corresponding to the display 702 of the electronic device 700 and another presentation region 773 that is complementary to the presentation region 772 of the display 702. As used herein, “complementary” takes the mathematical definition in which members of a first set are not members of a given subset. Accordingly, when the presentation region 772 is “complementary” to the another presentation region 773, each fits within an overall presentation region of the electronic device 700, but do not overlap.

In one embodiment, the control circuit 707 is operable to activate an application 710 configured for interactive application on a single display, i.e., the display 702 of the electronic device 700. It is contemplated that many operating systems of portable electronic devices presently do not allow for multiple applications to be operable on the display 702 of the electronic device 700 concurrently. Accordingly, applications are frequently designed to operate on only a single display. Embodiments of the disclosure are adapted to allow such applications to be presented on a remote device, yet controlled with the electronic device 700, without any reconfiguration of the application itself. Accordingly, embodiments of the disclosure can be used with “off the shelf” applications to provide superior user experiences by allowing those off the shelf applications to be used with remote devices having larger, and often better, displays.

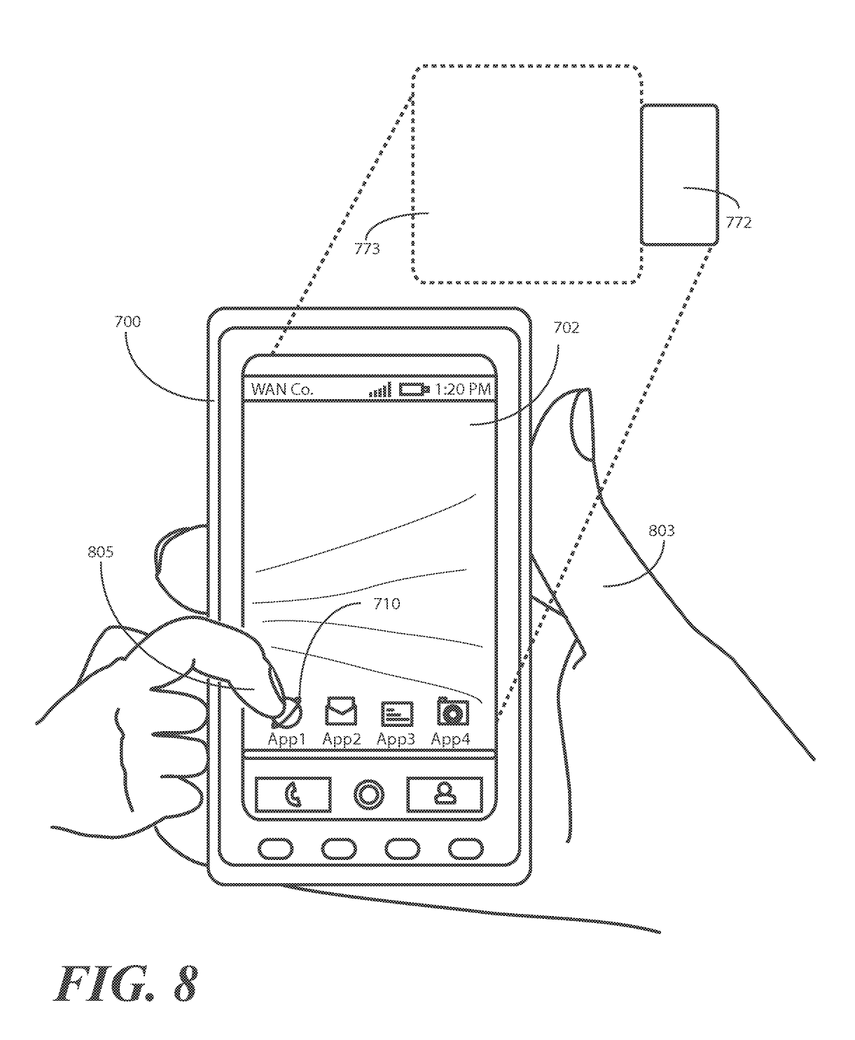

In one embodiment, the control circuit 707 then causes the communication circuit 703 to communicate presentation data of the application 710 for presentation on the remote device. In one embodiment, the control circuit 707 accomplishes this by presenting the presentation data in the presentation region 773 that is complementary to the presentation region 772 of the display 702. When this occurs, the control circuit 707 can present a control interface in the presentation region 772 of the display 702 to allow the user to control the presentation data with the control interface. The communication circuit 703 can communicate the user input received at the control interface to control the presentation data of the application 710 on the remote device. This will be illustrated in FIGS. 8-16.

Turning to FIG. 8, a user 803 is providing user input 805 to launch an application 710 on the electronic device 700. For reference, both the presentation region 772 of the display 702 of the electronic device 700 and the presentation region 773 complementary to the display 702 will be illustrated in FIGS. 8-16.

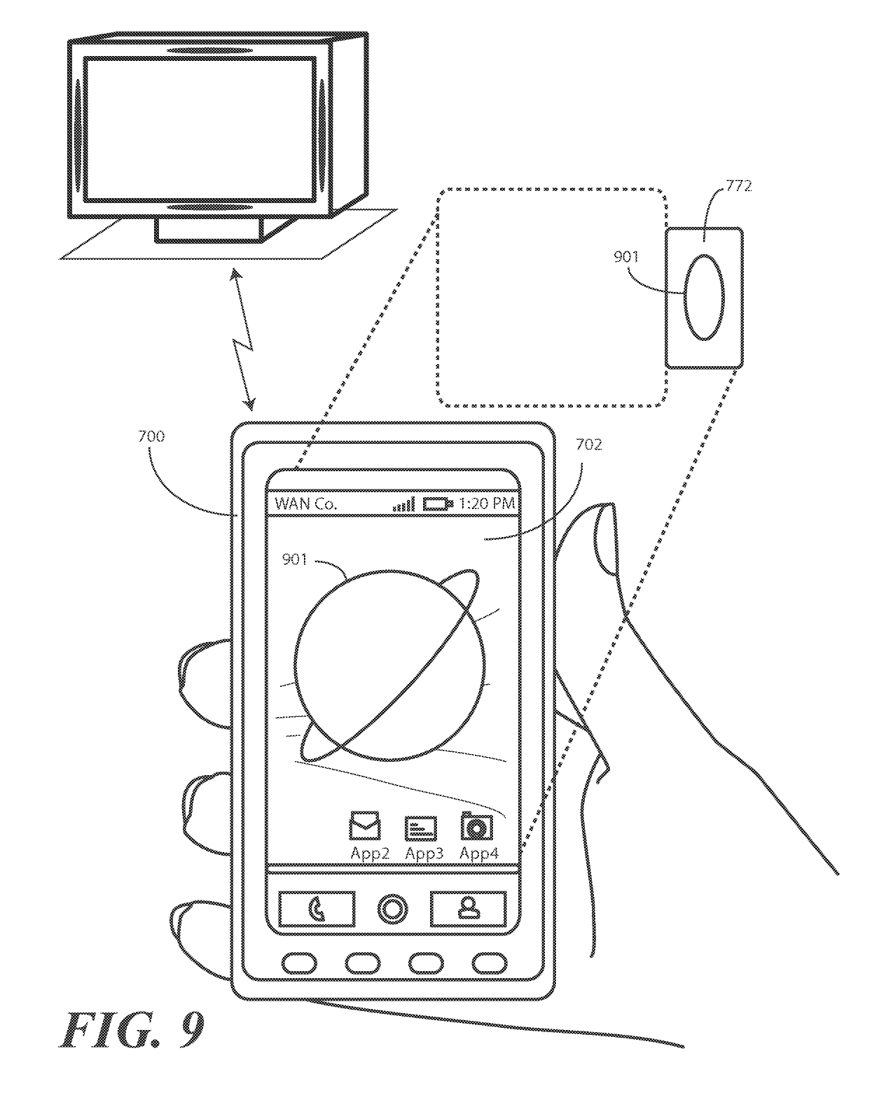

At FIG. 9, the control circuit (707) of the electronic device 700 presents presentation data 901 of the launched application on the display 702 of the electronic device 700. In one embodiment, the control circuit (707) does this by presenting the presentation data 901 in the presentation region 772 of the display 702 of the electronic device 700.

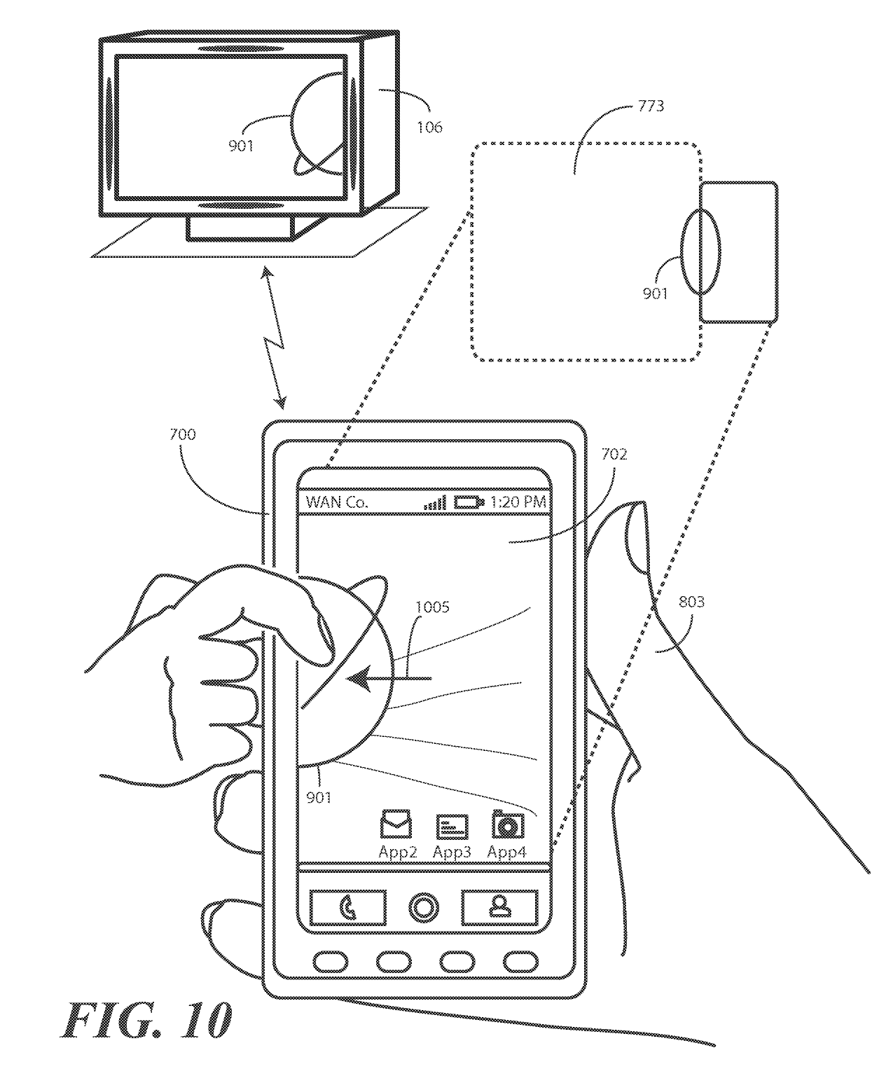

At FIG. 10, the user 803 provides additional user input 1005 to move the presentation data 901 of the launched application off the display 702 of the electronic device 700. As shown, this causes the presentation data 901 to move into the presentation region 773 complementary to the display 702. Recall that the launched application is configured for interactive operation on only a single display. Consequently, this user input 1005 will cause all of the presentation data 901 to move into the presentation region 773 complementary to the display 702. In one embodiment, the control circuit (707) thus communicates the presentation data 901 to the remote device 106 for presentation on its display.

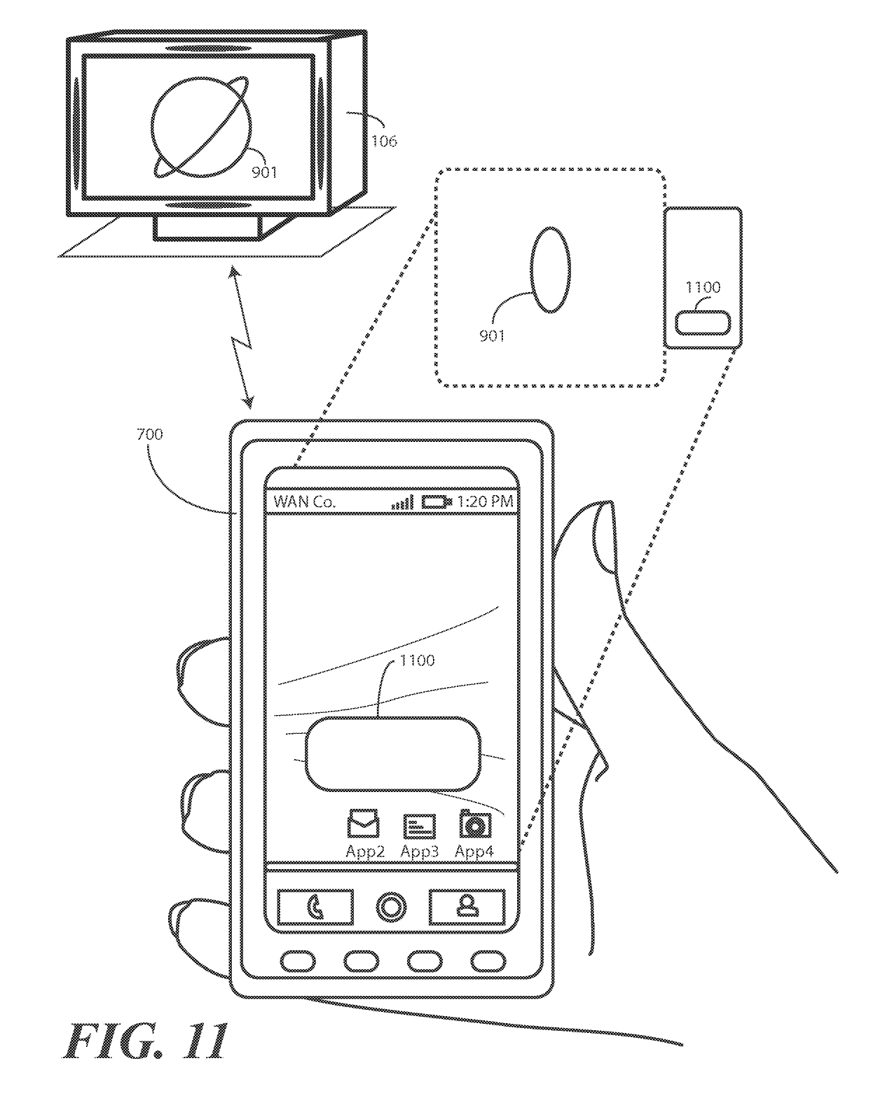

At FIG. 11, the control circuit (707) presents a control interface 1100 corresponding to the launched application on the display 702 of the electronic device 700. The control interface 1100 is for controlling the presentation data 901 of the launched application being presented on the remote device 106.

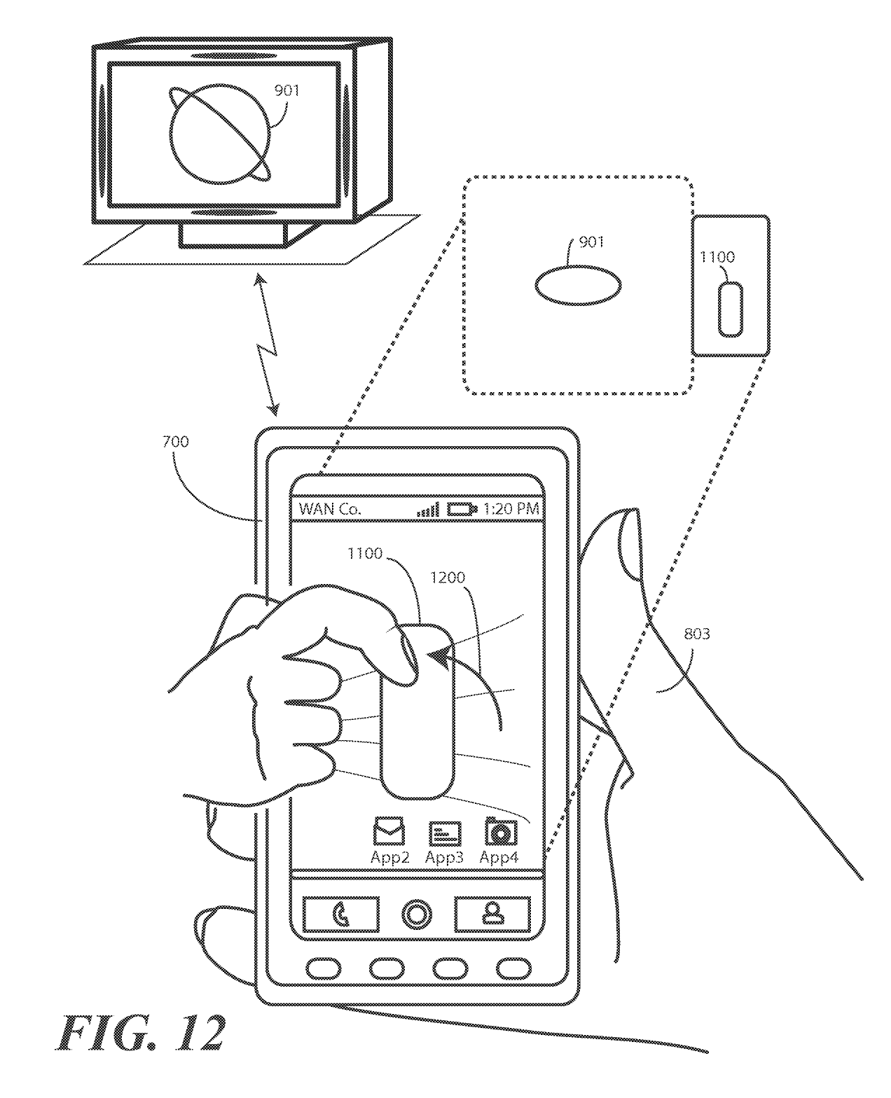

At FIG. 12, the user 803 is applying user input 1200 to the control interface 1100. In this illustrative embodiment, the user input 1200 comprises a rotational input. The control circuit (707) of the electronic device 700 then transforms this user input 1200 to correspond to input data for the launched application 710, which is also running on the control circuit (707) in this embodiment. The transformed input is received by the launched application, as if provided directly by the user to the launched application 710. The presentation data 901 is then changed in response to the transformed input by the control circuit (707). This changed presentation data 901 is then communicated to the remote device 106 to control the presentation data 901 of the launched application being displayed on the remote device 106. As shown, the presentation data 901 appears to have rotated by an amount proportional to the user input 1200.

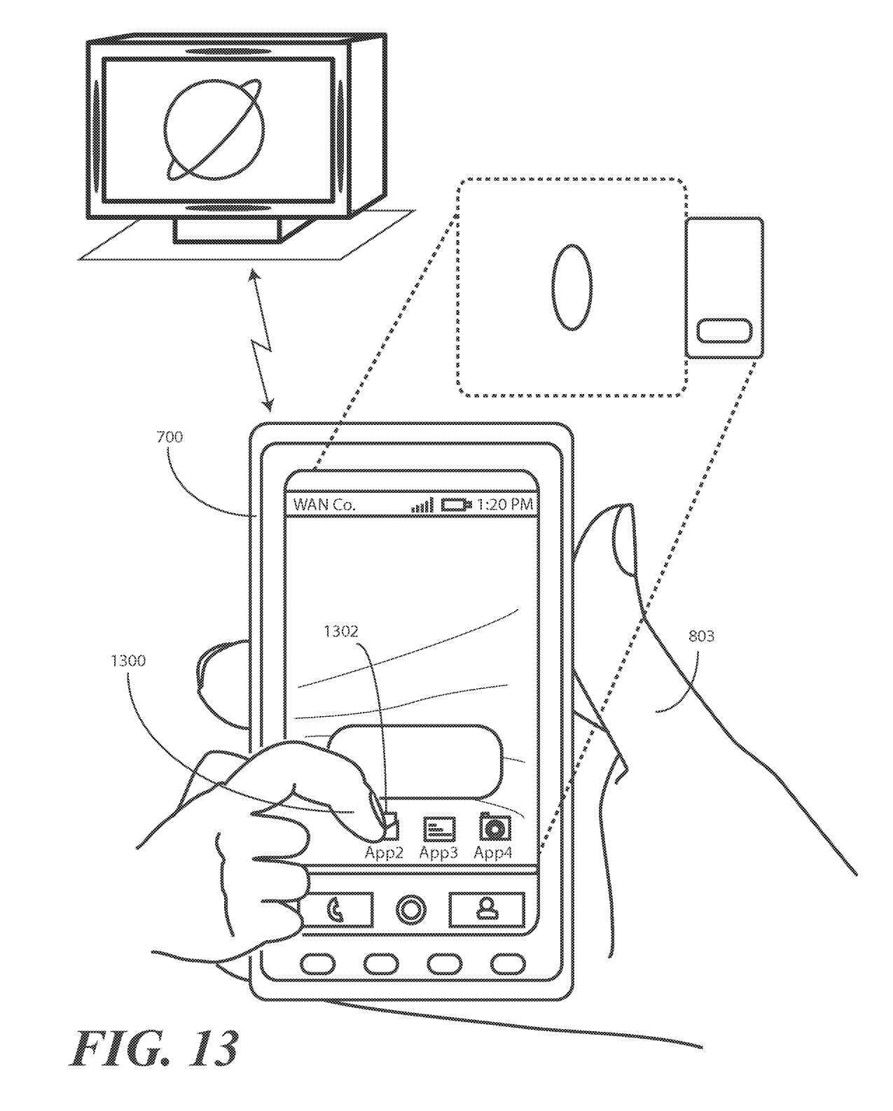

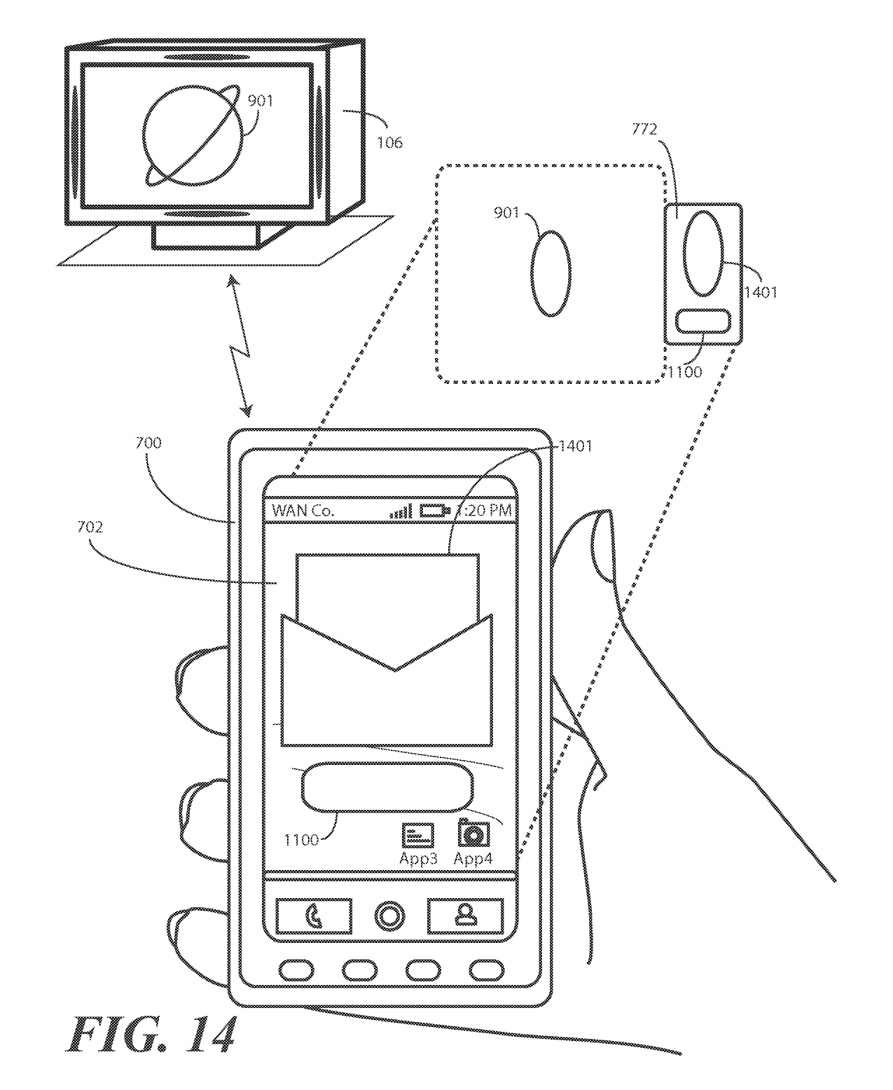

At FIG. 13, the user 803 is applying another user input 1300, which causes the control circuit (707) of the electronic device 700 to selectively launch another application 1301, which is different from the application (710) launched in FIG. 8. As shown in FIG. 14, presentation information 1401 of this second application 1301 is therefore presented on the display 702 of the electronic device 700. In one embodiment, the control circuit (707) does this by presenting the presentation information 1401 in the presentation region 772 of the display 702 of the electronic device 700. The control module 1100, used to control the presentation data 901 of the launched application being displayed on the remote device 106, remains on the display 702 as well. In this illustrative embodiment, the control module 1100 is being presented beneath the presentation information 1401 of the second application 1301, rather than floating above it. As noted above, in one or more embodiments, the control circuit (707) is configured to alter one of a size or a location of the control interface 1100 when presenting the presentation information 1401 of the second application 1301 on the display 702. In this illustrative embodiment, the control interface 1100 has become reduced in size and has moved lower on the display 702.

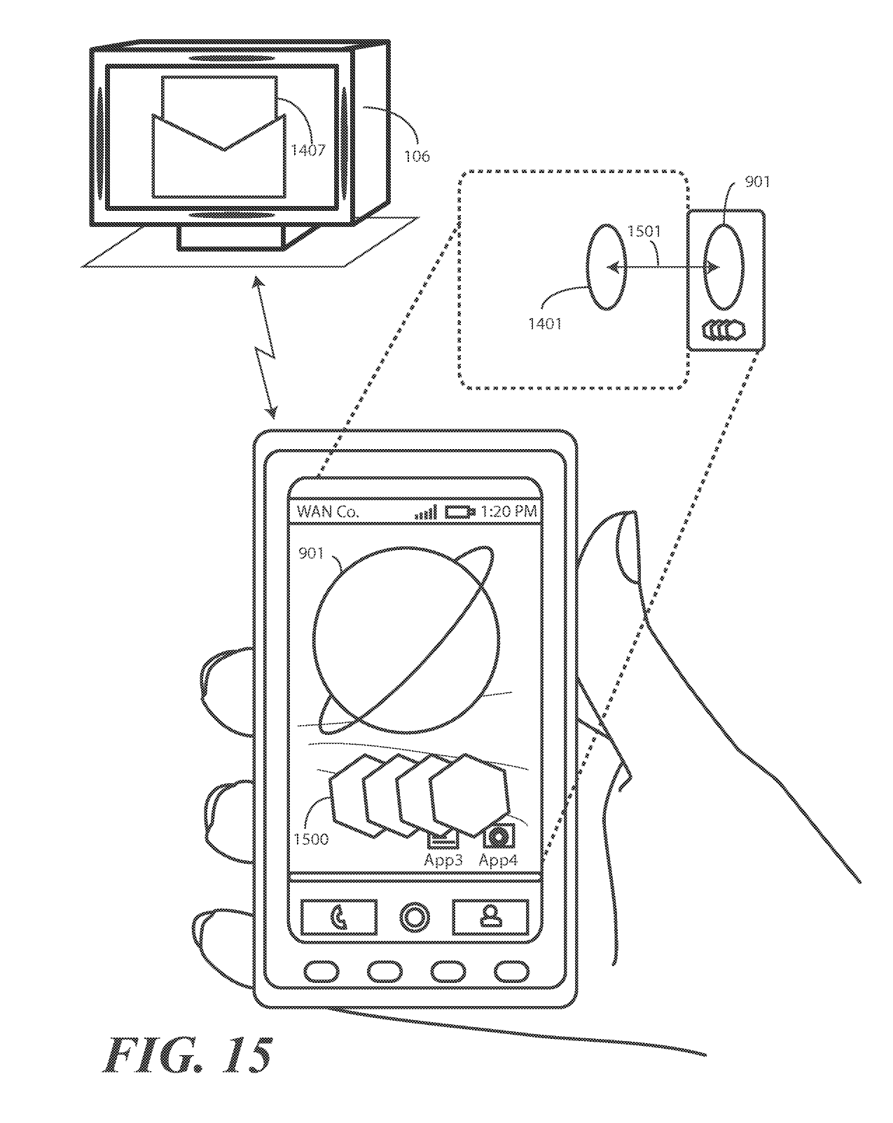

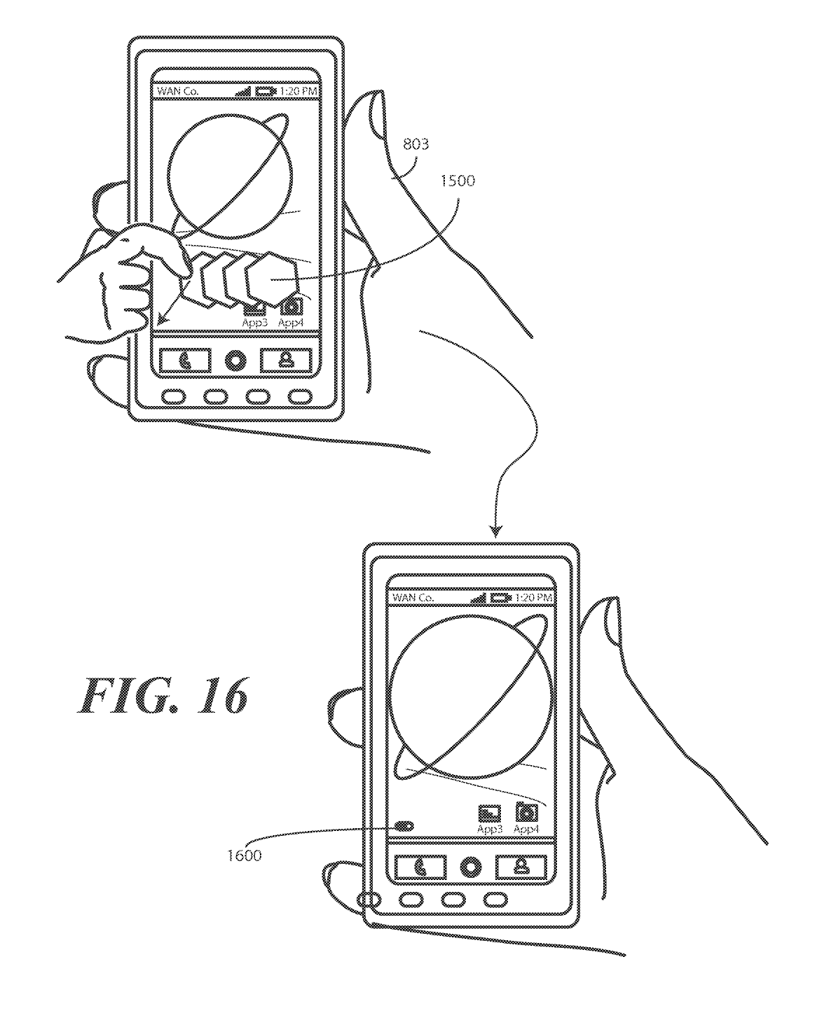

At FIG. 15, the user 803 has caused the presentation information to “flip” by providing user input 1501 that moves presentation information 901 from the remote device 106 to the display 702 of the electronic device 700. Correspondingly, presentation information 1401 has moved from the display 702 of the electronic device 700 to the display of the remote device 106. In effect, the information being presented on the remote device 106 has changed. This is the same as if the interactive application operating on the remote device 106 had changed in the examples shown in FIGS. 2-6 above. In one or more embodiments, when this occurs, the control interface 1500 also changes so as to correspond to the information being presented on the remote device 106. As shown in FIG. 15, the control interface 1500 is different from the control interface (1100) shown in FIG. 14 due to the change in information being presented on the remote device 106. The control interface 1500 of FIG. 15 is configured to control the presentation information 1407 being presented on the remote device 106. At FIG. 16, the user 803 is minimizing the control interface 1500 to a user interaction target 1600 when not in use.

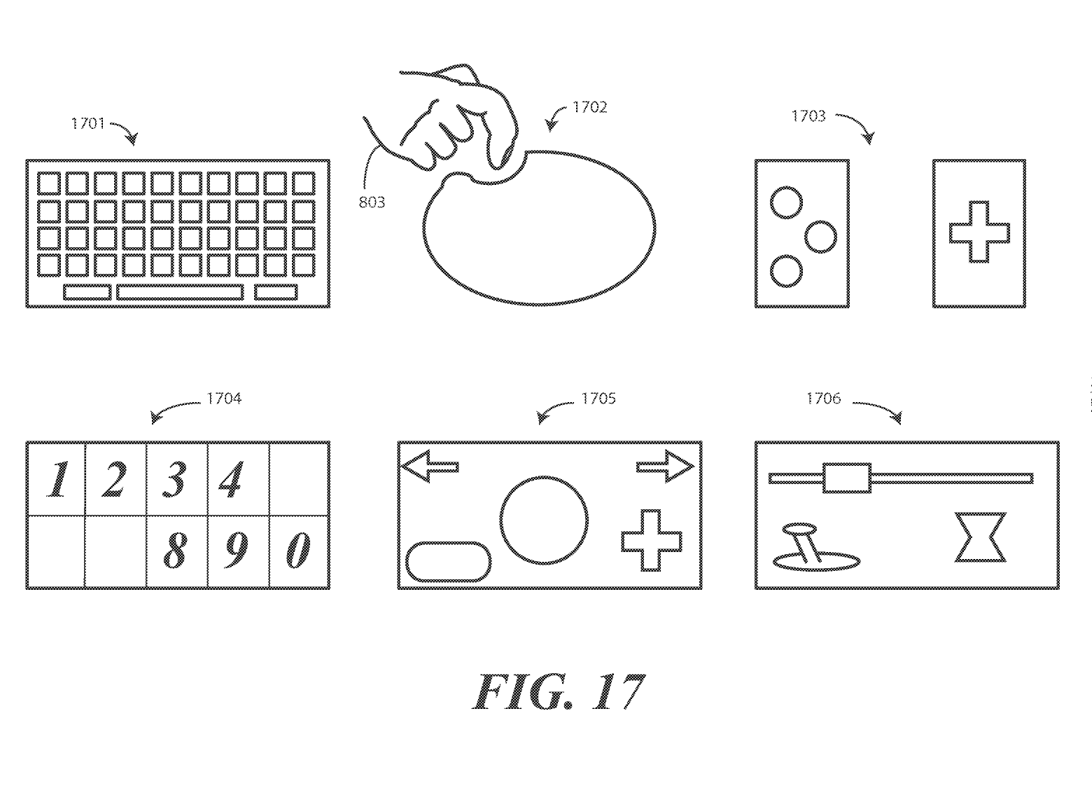

In the foregoing specification, specific embodiments of the present disclosure have been described. However, one of ordinary skill in the art appreciates that various modifications and changes can be made without departing from the scope of the present disclosure as set forth in the claims below. For instance, it has been explained that various control interfaces configured in accordance with embodiments of the disclosure can comprise touch sensitive interfaces that are visually indicative of one or more predetermined touch interactions operable to control an interactive application operating on, or having presentation data displayed on, a remote device. Examples of predetermined inputs have been described to include a touch input, a drag input, an extended touch input, a gesture input, or combinations thereof. When a control interface comprises a scrolling interface, it can be configured to receive a predetermined touch interaction that comprises a drag input in one embodiment. To provide even more examples of control interfaces, FIG. 17 illustrates just a few of the many examples that will be obvious to those of ordinary skill in the art having the benefit of this disclosure.

Turning now to FIG. 17, illustrated therein are just a few of the possible configurations of control interfaces that may be presented to control interactive applications operating on, or presentation data being presented on, a remote device in accordance with one or more embodiments of the disclosure. Each variation of FIG. 17 may optionally be associated with one or more predetermined touch input interactions to control what is being presented on the remote device. The embodiments of FIG. 17 are illustrative only, and that others may be created without departing from the scope of the disclosure.

Embodiment 1701 is a configured as a QWERTY keypad. A full QWERTY keypad can be implemented. Alternatively, variations or subsets of keys from a QWERTY keypad can be implemented to save space. Alternatively, multiple languages can be supported by dedicated user input attachments as previously described.

Embodiment 1702 is referred to as a “jelly bean” in that a user 803 can squeeze, stretch, rotate, slide, or otherwise manipulate a control interface configured as a virtual spongy ball to control interactive applications operating on, or presentation data being presented on, a remote device in accordance with one or more embodiments of the disclosure. Other variants of geometric shapes may also be created to receive gesture input.

Embodiment 1703 is a game control interface. Each piece can be presented on a touch sensitive display of an electronic device. As shown, one piece includes buttons and the other piece includes a D-pad. The embodiment 1703 can be user configurable to accommodate either a right-handed configuration (as shown) or a left-handed configuration.

Embodiment 1704 is a numerically specific control interface. Embodiment 1705 is an application specific control interface that includes features such as a navigational wheel, page back/forward keys, an enter key, and a D-pad.

Embodiment 1705 is a multifunction control interface keypad illustrating some of the varied user actuation targets that can be included in a control interface presented on a touch sensitive display. Such controls include virtual sliders (suitable for scrolling operations and for receiving drag or slide user input), virtual rockers, and virtual joysticks. Thus, while preferred embodiments of the disclosure have been illustrated and described, it is clear that the disclosure is not so limited. Numerous modifications, changes, variations, substitutions, and equivalents will occur to those skilled in the art without departing from the scope of the present disclosure as defined by the following claims.

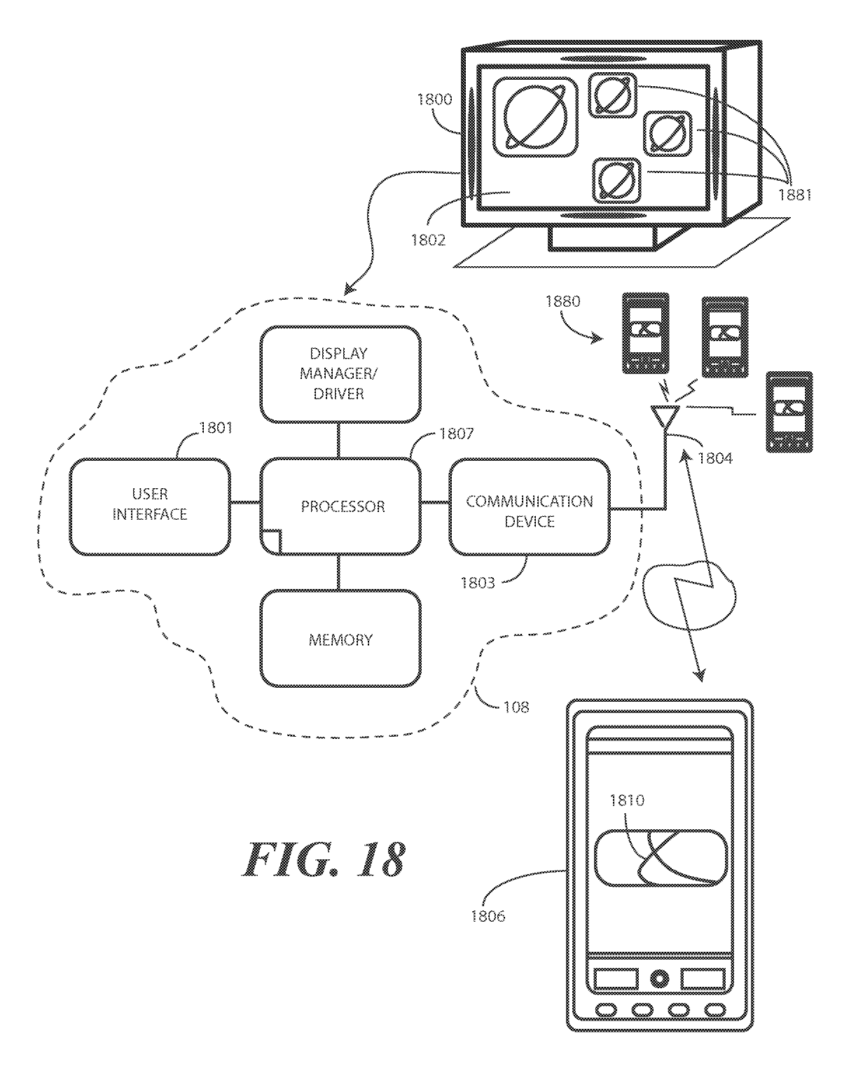

To this point, the device with the smaller display, i.e., the target device, has been described as receiving the user input to control an interactive application being presented on a device with a larger display, i.e., a remote device. It will be obvious to those of ordinary skill in the art having the benefit of this disclosure that embodiments of the disclosure could work in the opposite, with the user input being received at the remote device to control an interactive application operating on the target device. For example, in an interactive classroom, each student may be operating an educational application on their respective target devices. A teacher may be operating a remote device that is in communication with each of the devices. In such a use case, the teacher may want to provide user input at the remote device that can control the interactive application operating on a particular student's target device. Turning now to FIG. 18, illustrated therein is such an embodiment.

In FIG. 18, an explanatory remote device 1800 is configured in accordance with one or more embodiments of the disclosure. The illustrative remote device 1800 of FIG. 18 is shown as a television for illustration. However, it will be obvious to those of ordinary skill in the art having the benefit of this disclosure that other portable electronic devices may be substituted for the explanatory television of FIG. 18. For example, the remote device 1800 may be configured as a palm-top computer, a tablet computer, a gaming device, wearable computer, a media player, laptop computer, portable computer, or other device. In the “teacher-student” use case described in the preceding paragraph, for example, the remote device may be a tablet computer.

The explanatory remote device 1800 is shown illustratively in FIG. 18 in an operating environment, along with a schematic block diagram, incorporating explanatory embodiments of the present disclosure. As shown, the illustrative remote device 1800 may include standard components such as a user interface 1801. The user interface 1801 can include the display 1802, which in one embodiment is a touch sensitive display.

The illustrative remote device 1800 of FIG. 18 also includes a communication circuit 1803. The communication circuit 1803 can be configured for communication with one or more networks. In one embodiment, the network is a local area network or short-range network. The communication circuit 1803 can include wireless communication circuitry, one of a receiver, a transmitter, or transceiver, and one or more antennas 1804.

In one or more embodiments, the communication circuit 1803 can be configured for data communication with at least one local network. For illustration, the local area network can be a Wi-Fi network being supported by a router, base station, or access point. In the illustrative embodiment of FIG. 18, the communication circuit 1803 is communicating across the local area network with a target device 1806, shown illustratively here as a smart phone. It should be noted that the communication circuit 1803 can also be configured to communicate across other types of local area networks, including Bluetooth™ or other local area communication protocols. The target device 1806 is shown in FIG. 18 operating an interactive application 1810.

It should also be noted that the communication circuit 1803 could be configured to communicate with a plurality 1880 of target devices. Continuing with the teacher-student example from above, the teacher may desire her remote device be in communication with the target devices of each student. Accordingly, in one embodiment the communication circuit 1803 is configured to communicate with a plurality 1880 of target devices. As shown in FIG. 18, presentation data 1881 from each of the plurality 1880 of target devices can be displayed or minimized on the display 1802 of the remote device 1800 that is accessible to the teacher. Note that each target device of the plurality 1880 of target devices can run the same interactive application or different interactive applications. Even when running the same interactive application, each device of the plurality 1880 of target devices can run the interactive application 1810 at different stage of that application. For example, if students are taking a test using the interactive application 1810, each student may be on a different question of the test.

In this illustrative embodiment, the remote device 1800 includes a control circuit 1807, which in FIG. 18 is illustrated as one or more processors. The control circuit 1807 is responsible for performing the various functions of the device. The control circuit 1807 can be a microprocessor, a group of processing components, one or more Application Specific Integrated Circuits (ASICs), programmable logic, or other type of processing device. The control circuit 1807 can be operable with the user interface 1801 and the communication circuit 1803, as well as various peripheral ports (not shown) that can be coupled to peripheral hardware devices via interface connections.

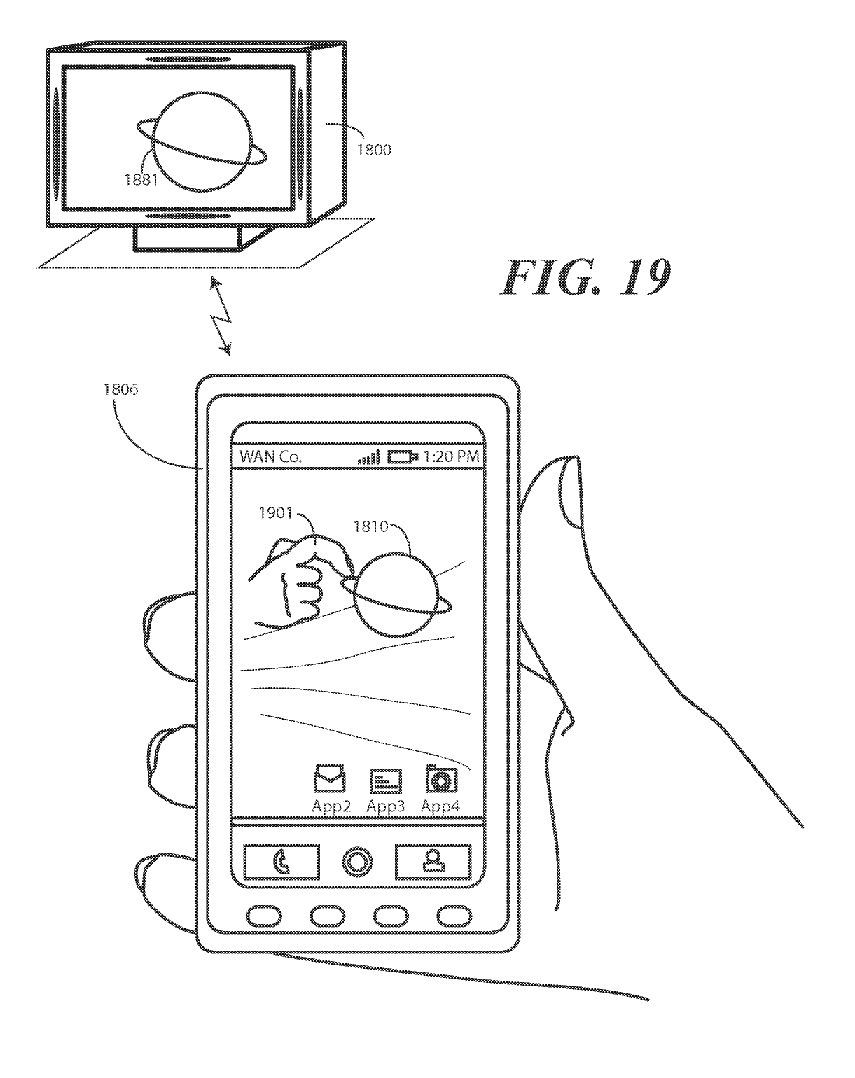

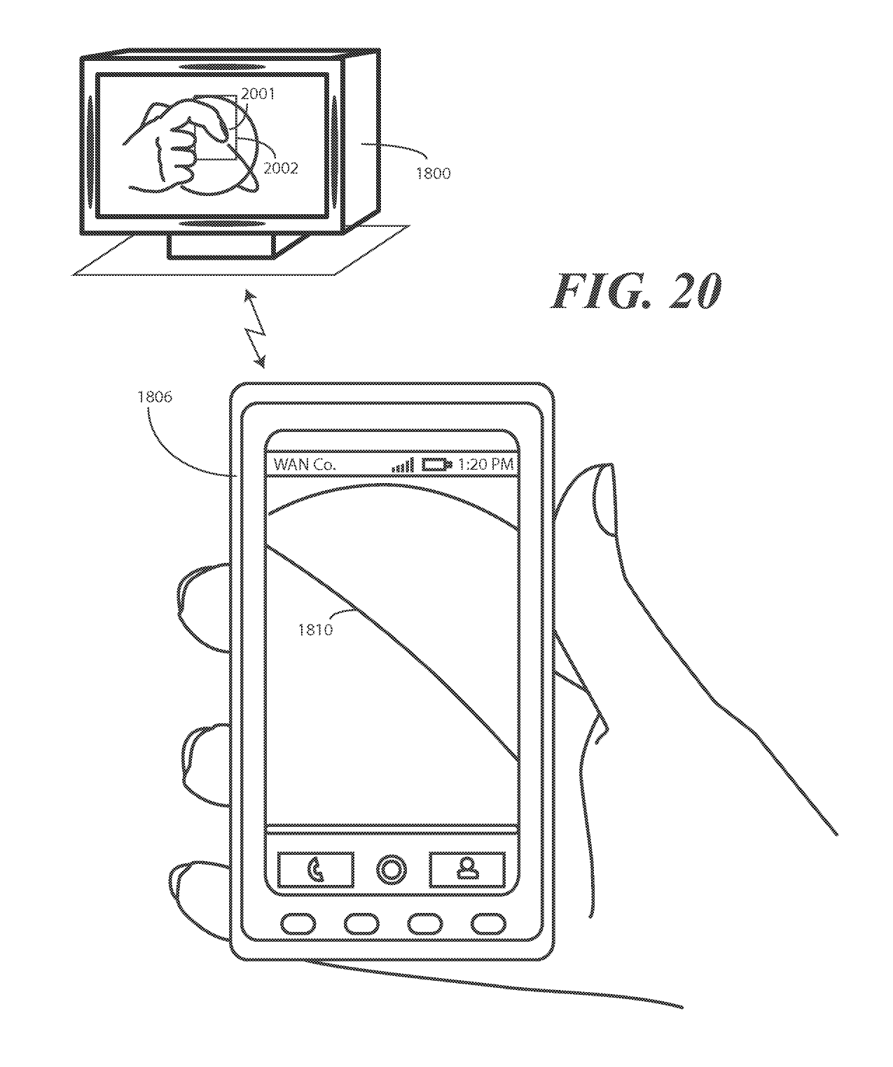

The control circuit 1807 can be configured to process and execute executable software code to perform the various functions of the electronic device 1800. A storage device, such as memory 108, stores the executable software code used by the control circuit 1807 for device operation. Such computer instructions can instruct processors or the control circuit 1807 to perform methods described below in FIGS. 19-20.

Turning now to FIGS. 19-20, illustrated therein is one explanatory method of operating the remote device 1800 of FIG. 18 in accordance with one or more embodiments of the disclosure. Initially, an interactive application 1810 is detected operating on the target device 1806. In one embodiment, the target device 1806 is in communication with a communication circuit (1803) of the remote device 1800. As shown in FIG. 19, a student 1901 can touch and/or operate the interactive application on the target device 1806, with the presentation data 1881 changing in response to the student input on the remote device 1800 accessible to the teacher.

In another embodiment, as shown in FIG. 20, the user interface (1801) of the remote device 1800 can be configured to allow a user to control the interactive application 1810 operating on the target device 1806 via the display 1802 or other user interface (1801) of the remote device 1800. User input can be received at the display 1802 or user interface (1801) of the remote device 1800.

In one embodiment, the user input 2001 received at the remote device 1800 can be communicated to the target device 1806 to control the interactive application 1810. Accordingly, a teacher can select, open, control, launch, or close the interactive application 1810 operating on the target device 1806. In one or more embodiments, the user input 2001 can be associated with expected types of user input or interactions. For example, the user input 2001 may be associated with dragging motions. Similarly, the user input 2001 may be associated with touch input. While touch and drag interactions are two examples of expected interactions, it should be obvious to those of ordinary skill in the art having the benefit of this disclosure that other interactions could be expected as well, including extended touch, gestures, patterns, and so forth. In another embodiment, the communication circuit (1803) of the remote 1800 device can communicate user input 2001 received at the remote device 1800 to a runtime component operating on the target device 1806 to control the interactive application 1810.

In one embodiment, control circuit 1807 of the target device 1806 can communicate a control mapping 2002 of control interface data to the remote device 1800 to be superimposed on a portion of information of the interactive application 1810 to demonstrate information that, when within the control mapping 2002, will be visible on the target device 1806. This control mapping 2002 allows the user to easily identify what portion of the information of the interactive application 1810 will be seen on the display of the target device 1806. In one embodiment, this control mapping 2002 is user definable in that a user may expand and shrink the control mapping 2002 based upon a desired resolution. Accordingly, in the teacher-student use case, the teacher may resize the control mapping 2002 to determine what portion of the output of the interactive application 1810 is visible on the target device 1806.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A device, comprising;
a display;
a communication circuit;
a control circuit to:
detect, with the communication circuit, an interactive application operating on another device;
present a control interface on the display to receive user input for interactive regions of the interactive application; and
communicate the user input, mapped to the interactive regions of the interactive application, to the another device to control the interactive application.

2. The device of claim 1, the control interface comprising a mapping of a portion of information of the interactive application visible on the another device on the display.

3. The device of claim 2, the portion of information comprising a user control region of the interactive application.

4. The device of claim 1, the control circuit to communicate a mapping of control interface data to the another device to be superimposed on a portion of information of the interactive application visible on the another device.

5. The device of claim 4, the mapping of control interface data comprising a cursor.

6. The device of claim 1, the control interface comprising a touch sensitive interface visually indicative of one or more predetermined touch interactions operable to control the interactive application.

7. The device of claim 6, the one or more predetermined touch interactions comprising a touch input, a drag input, an extended touch input, a gesture input, or combinations thereof.

8. The device of claim 7, the one or more predetermined touch interactions comprising the drag input, the control interface comprising a scrolling surface.

9. The device of claim 1, the control interface comprising a select one of a plurality of predefined control interfaces stored in a memory, each of the plurality of predefined control interfaces associated with a predetermined touch control interaction.

10. The device of claim 1, the control circuit to present the control interface on only a portion of the display.

11. The device of claim 10, the portion of the display comprising a user configurable portion.

12. The device of claim 1, the control circuit to selectively launch an application in response to another user input, the application different from the interactive application; and
present information of the application on the display.

13. The device of claim 12, the control circuit to float the control interface above the information of the application.

14. The device of claim 1, the control circuit to change the control interface when the interactive application operating on the another device changes.

15. An electronic device, comprising:
a display;
a communication circuit; and
a control circuit to:
activate an application configured for interactive operation on a single display;
cause the communication circuit to communicate presentation data of the application for presentation on a remote display device;
present a control interface for the application on the display; and
communicate user input received at the control interface to control the presentation data of the application on the remote display device.

16. The electronic device of claim 15, the control circuit to launch, in response to another user input, another application and to present information of the another application on the display.

17. The electronic device of claim 16, the control circuit to alter one of a size or a location of the control interface when presenting the presentation data of the another application on the display.

18. A method of operating an electronic device, comprising:
detecting, with a control circuit, an interactive application operating on a remote device in communication with the electronic device;
presenting, via the control circuit, a control interface to control the interactive application from user input received at a user interface of the electronic device; and
communicating the user input to the remote device to control the interactive application.

19. The method of claim 18, further comprising mapping the user input to interactive regions of the interactive application.

20. The method of claim 18, further comprising mapping a portion of information of the interactive application visible on the remote device in the control interface.
